(19) United States
(12) Patent Application Publication
(10) Pub. No.: US 2015/0029413 A1
(43) Pub. Date: Jan. 29, 2015

(54) TOUCH DISPLAY APPARATUS

(71) Applicant: HIMAX TECHNOLOGIES LIMITED, Tainan City (TW)

(72) Inventors: Yaw-Guang Chang, Tainan City (TW); Chao-Wen Wu, Tainan City (TW)

(73) Assignee: HIMAX TECHNOLOGIES LIMITED, Tainan City (TW)

(21) Appl. No.: 14/189,763

(22) Filed: Feb. 25, 2014

Related U.S. Application Data
(60) Provisional application No. 61/859,294, filed on Jul. 28, 2013.

(30) Foreign Application Priority Data
Nov. 13, 2013 (TW) 102141305

(51) Int. Cl. G06F 3/041

(52) U.S. Cl. CPC G06F 3/0412
USPC 349/12

(57) ABSTRACT

A touch display apparatus is provided. Data lines are used to transmit display data signals or touch scan signals during different periods, wherein the data lines, the scan lines of the touch display apparatus and touch sensing lines of the touch display apparatus are disposed on a same substrate.

### CROSS-REFERENCE TO RELATED APPLICATION

This application claims the priority benefits of U.S. provisional application Ser. No. 61/859,294, filed on Jul. 28, 2013 and Taiwan application serial no. 102141305, filed on Nov. 13, 2013. The entirety of each of the above-mentioned patent applications is hereby incorporated by reference herein and made a part of this specification.

### BACKGROUND

1. Technical Field

The invention relates to an electronic apparatus. Particularly, the invention relates to a touch display apparatus.

2. Related Art

Regarding a general planar display apparatus, an image thereof is composed of a two-dimensional (2D) pixel array. In view of a driving mechanism, the planar display apparatus has horizontal scan lines and vertical data lines for driving color and grayscale of each pixel. In a conventional touch panel, for example, a resistive or a capacitive touch panel, measurement of two directions is performed to determine a touch event and a position of a touch point. Along with progress of manufacturing technology, touch panel has been successfully integrated to display panel, so as to achieve more effective and convenient control.

Although the touch panel has been successfully integrated to the display panel, the integration technique of the touch panel and the display panel is still required to be improved. In the conventional technique, data line signals and scan line signals used for driving the touch display apparatus to display images and touch scan signals and touch sensing signals used for driving the touch display apparatus to perform touch sensing operations are respectively transmitted through different transmission lines (i.e., through data lines, scan lines, touch scan lines and touch sensing lines, etc.). Moreover, since the touch sensing lines and the other signal transmission lines (for example, the data lines, the scan lines and the touch scan lines) are configured in different layers, two different flexible printed circuit (FPC) boards are required to be configured between a touch chip and a touch display panel for respectively transmitting and receiving the touch scan signals on the touch scan lines and the touch sensing signals on the touch sensing lines in the touch display panel, and assembling of the FPC boards probably decreases a production yield.

### SUMMARY

The invention is directed to a touch display apparatus with decreased manufacturing cost improved production yield.

The invention provides a touch display apparatus including a first substrate, a plurality of data lines, a plurality of scan lines, a plurality of touch sensing lines and a second substrate. The data lines, the scan lines and the touch sensing lines are disposed on the first substrate, and during a display driving period, the data lines are used to transmit display data signals to a plurality of corresponding pixel units, and the scan lines are used to transmit scan line signals to the corresponding pixel units. During a touch period, at least a part of the data lines are used to transmit touch scan signals to a plurality of corresponding touch units, and the touch sensing lines are used to receive touch sensing signals from the corresponding touch units. The second substrate is disposed above the first substrate.

In an embodiment of the invention, the touch display apparatus further includes a display driving chip, which is disposed on the first substrate, and is coupled to the pixel units through the data lines and the scan lines, and is used for outputting the display data signals, the scan line signals and the touch scan signals.

In an embodiment of the invention, the touch display apparatus further includes a touch chip, which is coupled to the touch sensing lines through a flexible printed circuit board, and receives the touch sensing signals from the touch sensing lines.

In an embodiment of the invention, the touch display apparatus further includes a motherboard control unit, which is coupled to the display driving chip and the touch chip through the flexible printed circuit board, and controls the display driving chip to output the display data signals, the scan line signals and the touch scan signals, and controls the touch chip to receive the touch sensing signals.

In an embodiment of the invention, the touch display apparatus further includes a touch chip, which is disposed on the first substrate and is coupled to the touch sensing lines, and receives the touch sensing signals from the touch sensing lines.

In an embodiment of the invention, the touch chip is disposed outside the display driving chip, or is integrated with the display driving chip.

In an embodiment of the invention, the touch chip further transmits a common voltage signal to the pixel units through the touch sensing lines during the display driving period.

In an embodiment of the invention, the first substrate is a thin-film transistor substrate, and the second substrate is a color filter substrate.

In an embodiment of the invention, the touch display apparatus further includes a protection lens disposed above the color filter substrate.

According to the above descriptions, the data lines are used to transmit display data signals or touch scan signals during different periods, and the data lines, the scan lines and the touch sensing lines are disposed on the same substrate, so as to reduce the number of used the flexible printed circuit boards and reduce the manufacturing cost of the touch display apparatus and meanwhile improve the production yield.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a touch display apparatus according to an embodiment of the invention.

FIG. 1B is a side view of the touch display apparatus of the embodiment of FIG. 1A.

FIG. 2A is a schematic diagram of a touch display apparatus according to another embodiment of the invention.

FIG. 2B is a side view of the touch display apparatus of the embodiment of FIG. 2A.

FIG. 3A is a schematic diagram of a touch display apparatus according to another embodiment of the invention.

FIG. 3B is a side view of the touch display apparatus of the embodiment of FIG. 3A.

### DETAILED DESCRIPTION OF DISCLOSED EMBODIMENTS

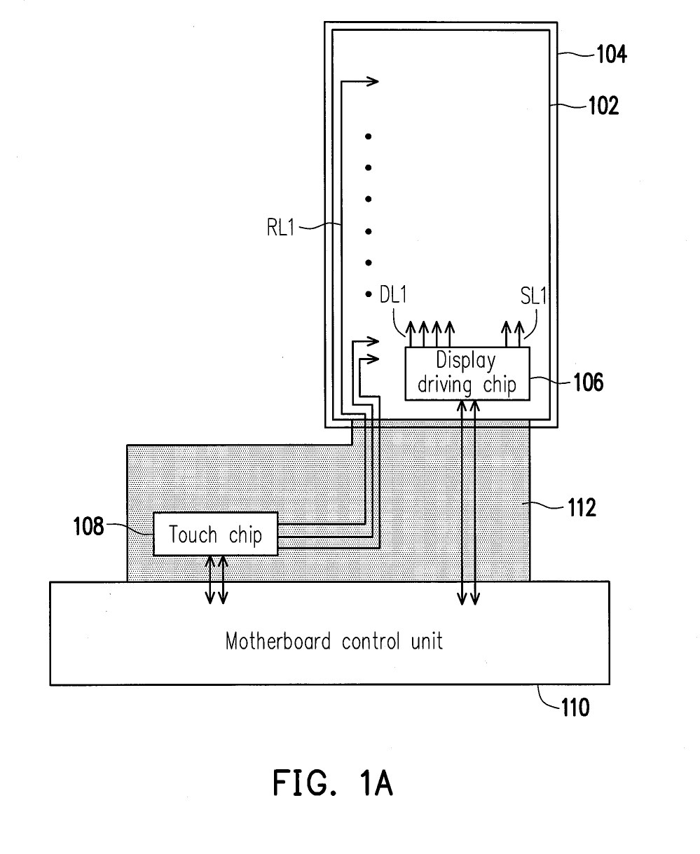

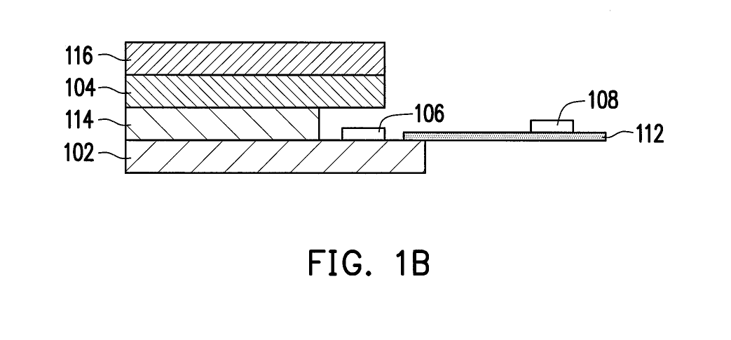

FIG. 1A is a schematic diagram of a touch display apparatus according to an embodiment of the invention, and FIG. 1B is a side view of the touch display apparatus of the embodiment of FIG. 1A. Referring to FIG. 1A and FIG. 1B, the touch display apparatus includes a first substrate 102, a second substrate 104, a plurality of data lines DL1, a plurality of scan lines SL1, a plurality of touch sensing lines RL1, a display driving chip 106, a touch chip 108 and a motherboard control unit 110. The first substrate 102 is, for example, a thin-film transistor substrate, and the second substrate 104 is, for example, a color filter substrate, and as that shown in FIG. 1B, the second substrate 104 is disposed above the first substrate 102. Further, the touch display apparatus may further include a protection lens 116 (which is not illustrated in FIG. 1A for simplicity's sake), which is disposed above the second substrate 104 (i.e. the color filter substrate) for protecting components on the first substrate 102 and the second substrate 104.

Moreover, the data lines DL1, the scan lines SL1, the touch sensing lines RL1 and the display driving chip 106 are disposed on the first substrate 102. In FIG. 1B, an active layer 114 sandwiched between the first substrate 102 and the second substrate 104 may include active devices such as thin-film transistors having gate electrodes made of indium tin oxide, i.e. may include pixel units (not shown) used for display images and touch units (not shown) used for touch detection. The display driving chip 106 is coupled to a plurality of pixel units on the first substrate 102 through the data lines DL1 and the scan lines SL1, and the touch chip 108 is coupled to the touch sensing lines RL1 through a flexible printed circuit (FPC) board 112, and is further coupled to a plurality of touch units. Moreover, the motherboard control unit 110 is coupled to the driving chip 106 and the touch chip 108 through the FPC board 112.

Each frame of the touch display apparatus may include a display driving period and a touch period, and during the display driving period, the motherboard control unit 110 can control the display driving chip 106 to transmit display data signals and scan line signals to the corresponding pixel units though the data lines DL1 and the scan lines SL1, and meanwhile the touch chip 108 also transmits a common voltage signal to the pixel unit through the FPC board 112 and the touch sensing lines RL1, and the touch display apparatus accordingly displays an image. During the touch period, the motherboard control unit 110 controls the touch chip 108 to transmit the touch scan signals to the corresponding touch units through the data lines DL1, and receives the touch sensing signals from the touch units corresponding to the touch sensing lines RL1 through the touch sensing lines RL1, so as to determine a touch position according to the touch sensing signals. It should be noticed that during the touch detection, since a distribution density of the touch units is unnecessary to be as higher as a distribution density of the pixel units in order to reach a good touch detecting effect, when the touch chip 108 transmits the touch scan signals, the touch chip 108 may transmit the touch scan signals through only a part of the data lines DL1.

As that described above, since the data lines DL1 can be respectively used to transmit the display data signals and the touch scan signals during the display driving period and the touch period, and in the present embodiment, the data lines DL1, the scan lines SL1 and the touch sensing lines RL1 are all located in a same layer (all located on the first substrate 102), the touch display apparatus of the present embodiment only requires one piece of the FPC board 112 to reach the purpose of transmitting the touch scan signals and the touch sensing signals without using two pieces of the FPC boards to respectively connect the touch sensing lines and the touch scan lines on the touch display panel as that does of the conventional technique. Therefore, the configuration method of the signal transmission lines of the present embodiment may effectively improve the production yield and reduce the manufacturing cost.

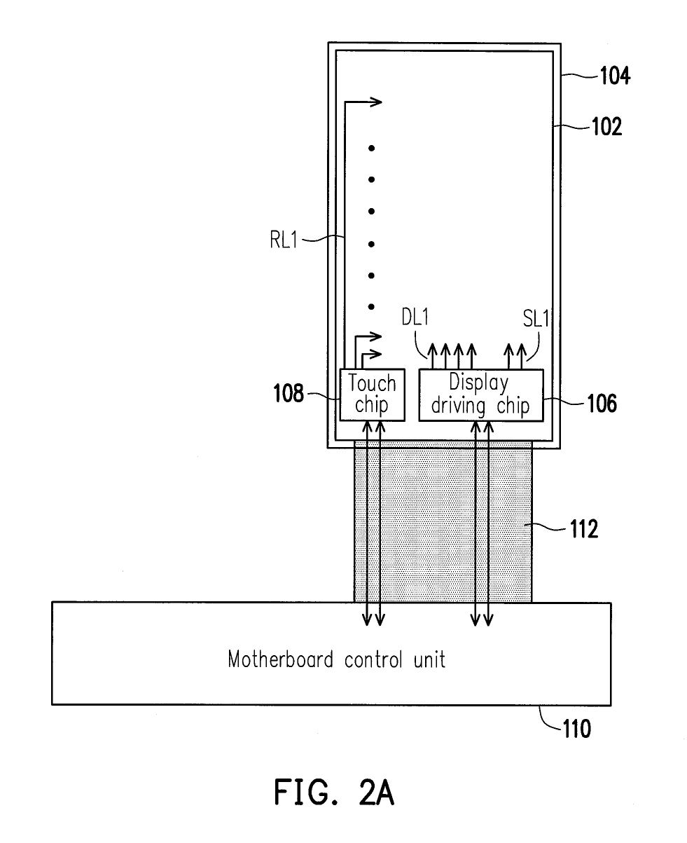

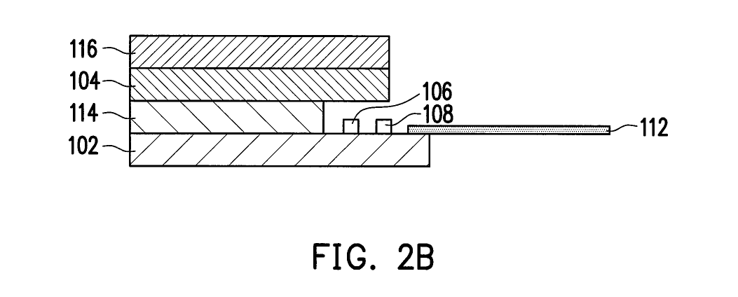

FIG. 2A is a schematic diagram of a touch display apparatus according to another embodiment of the invention, and FIG. 2B is a side view of the touch display apparatus of the embodiment of FIG. 2A. Referring to FIG. 2A and FIG. 2B, a difference between the embodiment of FIG. 2A and FIG. 2B and the embodiment of FIG. 1A and FIG. 1B is that in the embodiment of FIG. 2A and FIG. 2B, the touch chip 108 is disposed on the first substrate 102. In this way, it is unnecessary to use the FPC board 112 to couple the touch chip 108 and the touch sensing lines RL1, so as to avoid a damage of the FPC board 112 possibly occurred when the FPC board 112 is bonded, and accordingly improve the production yield.

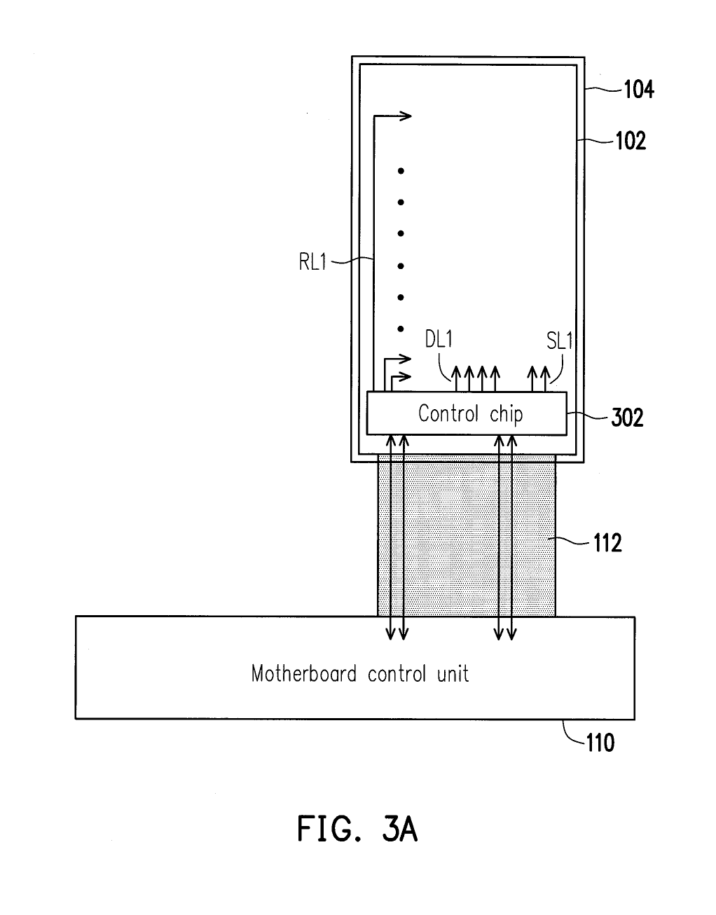

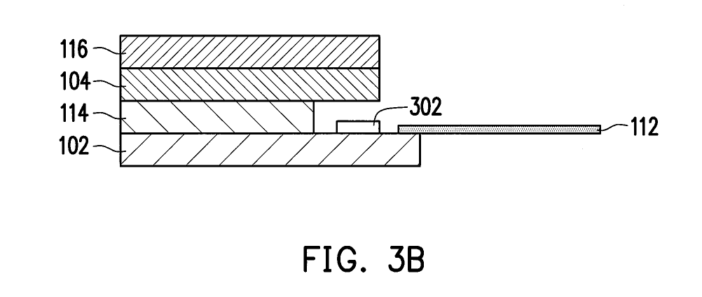

FIG. 3A is a schematic diagram of a touch display apparatus according to another embodiment of the invention, and FIG. 3B is a side view of the touch display apparatus of the embodiment of FIG. 3A. Referring to FIG. 3A and FIG. 3B, a difference between the embodiment of FIG. 3A and FIG. 3B and the embodiment of FIG. 2A and FIG. 2B is that in the embodiment of FIG. 3A and FIG. 3B, the touch chip 108 can be directly integrated with the display driving chip 106 without being disposed outside the display driving chip 106 as that does in the embodiment of FIG. 2A and FIG. 2B. In the present embodiment, a device integrating the touch chip 108 and the display driving chip 106 is represented by a control chip 302.

In summary, the data lines are used to transmit display data signals or touch scan signals during different periods, and the data lines DL1, the scan lines SL1 and the touch sensing lines RL1 are disposed on the same substrate, so as to reduce the number of used the flexible printed circuit boards and reduce the manufacturing cost of the touch display apparatus and meanwhile improve the production yield.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display apparatus, comprising:
a first substrate;
a plurality of data lines;
a plurality of scan lines;
a plurality of touch sensing lines, wherein the data lines, the scan lines and the touch sensing lines are disposed on the first substrate, and during a display driving period, the data lines are used to transmit display data signals to a plurality of corresponding pixel units, and the scan lines are used to transmit scan line signals to the corresponding pixel units, during a touch period, at least a part of the data lines are used to transmit touch scan signals to a plurality of corresponding touch units, and the touch sensing lines are used to receive touch sensing signals from the corresponding touch units; and
a second substrate, disposed above the first substrate.

2. The touch display apparatus as claimed in claim 1, further comprising:
a display driving chip, disposed on the first substrate, and coupled to the pixel units through the data lines and the scan lines, and outputting the display data signals, the scan line signals and the touch scan signals.

3. The touch display apparatus as claimed in claim 2, further comprising:
a touch chip, coupled to the touch sensing lines through a flexible printed circuit board, and receiving the touch sensing signals from the touch sensing lines.

4. The touch display apparatus as claimed in claim 3, further comprising:
a motherboard control unit, coupled to the display driving chip and the touch chip through the flexible printed circuit board, and controlling the display driving chip to output the display data signals, the scan line signals and the touch scan signals, and controlling the touch chip to receive the touch sensing signals.

5. The touch display apparatus as claimed in claim 2, further comprising:
a touch chip, disposed on the first substrate, and coupled to the touch sensing lines, and receiving the touch sensing signals from the touch sensing lines.

6. The touch display apparatus as claimed in claim 5, wherein the touch chip is disposed outside the display driving chip, or is integrated with the display driving chip.

7. The touch display apparatus as claimed in claim 5, further comprising:
a motherboard control unit, coupled to the display driving chip and the touch chip through a flexible printed circuit board, and controlling the display driving chip to output the display data signals and the touch scan signals, and controlling the touch chip to receive the touch sensing signals.

8. The touch display apparatus as claimed in claim 1, wherein the touch chip further transmits a common voltage signal to the pixel units through the touch sensing lines during the display driving period.

9. The touch display apparatus as claimed in claim 1, wherein the first substrate is a thin-film transistor substrate, and the second substrate is a color filter substrate.

10. The touch display apparatus as claimed in claim 9, further comprising:
a protection lens, disposed above the color filter substrate.
